(19) United States
(12) Patent Application Publication
(10) Pub. No.: US 2023/0169775 A1
(43) Pub. Date: Jun. 1, 2023

(54) AUTONOMOUS DRIVING SYSTEM

(71) Applicant: Mitsubishi Electric Corporation, Tokyo (JP)

(72) Inventors: Takuya TANIGUCHI, Tokyo (JP); Eri KUWAHARA, Tokyo (JP); Genki TANAKA, Tokyo (JP)

(73) Assignee: Mitsubishi Electric Corporation, Tokyo (JP)

(21) Appl. No.: 17/976,065

(22) Filed: Oct. 28, 2022

(30) Foreign Application Priority Data
Nov. 29, 2021 (JP) 2021-192673

(51) Int. Cl. G06V 20/54; G06V 20/58; B60W 60/00; B60W 30/09; B60W 30/095

(52) U.S. Cl. CPC G06V 20/54; G06V 20/58; B60W 60/0015; B60W 30/09; B60W 30/0956; G01S 13/865

(57) ABSTRACT

If there is a detection point that is erroneously recognized as an obstacle even though the detection point indicates a control-target vehicle, an obstacle that does not exist has been detected near the control-target vehicle. Consequently, the control-target vehicle might become unable to autonomously travel in an attempt to avoid a collision with the erroneously recognized obstacle. Considering this, an object indicated by a detection point that is detected by a road-side sensor and that exists within a certain distance range from a position of a control-target vehicle specified by an image recognition camera of a road-side unit, is not regarded as an obstacle.

### BACKGROUND OF THE INVENTION

### 1. Field of the Invention

The present disclosure relates to an autonomous driving system.

### 2. Description of the Background Art

An autonomous driving system has been known in which, in a region in which road-side units for detecting an obstacle are placed in advance, obstacle positional information and high-accuracy map information about the region are received from the road-side units, and autonomous travel is performed in the region on the basis of these pieces of information (see, for example, Patent Document 1).

Patent Document 1: Japanese Laid-Open Patent Publication No. 2016-57677

In the case of the autonomous driving system as in Patent Document 1, each road-side unit is provided with a road-side sensor which is mounted with an image recognition camera, a laser radar, a millimeter wave radar, or the like. An obstacle is detected by the road-side sensor, and autonomous driving is performed so as to avoid the obstacle on the basis of the detected information. However, in this case, the road-side sensor detects not only an obstacle near a control-target vehicle to be subjected to autonomous driving control but also the control-target vehicle in the same manner. In this case, it is difficult to determine whether the detected object is an obstacle or the control-target vehicle. This is because a position of the control-target vehicle detected by the image recognition camera of one of the road-side sensors does not necessarily overlap with a position of the control-target vehicle detected by the image recognition camera of another one of the road-side sensors. Likewise, positions of the control-target vehicle detected by the laser radars also do not necessarily overlap with each other, and positions of the control-target vehicle detected by the millimeter wave radars also do not necessarily overlap with each other.

If there is a detection point that is erroneously recognized as an obstacle even though the detection point indicates a control-target vehicle, an obstacle that does not exist has been detected near the control-target vehicle. Consequently, the control-target vehicle might become unable to autonomously travel in an attempt to avoid a collision with the erroneously recognized obstacle.

Against this drawback, Patent Document 1 discloses: a method for detecting nearby obstacles by the monitoring camera mounted to the road-side unit; and a method for removing, through image recognition by the monitoring camera, a nearby obstacle that is located within a range in which the control-target object is recognized. However, since the road-side unit is mounted with not only the monitoring camera but also various obstacle detection sensors such as the laser radar and the millimeter wave radar, a problem arises in that, if an error from a position detected by the monitoring camera is present regarding an obstacle detected by an obstacle detection sensor other than the monitoring camera, erroneous recognition of the obstacle cannot be prevented.

### SUMMARY OF THE INVENTION

The present disclosure has been made to solve the above problem, and an object of the present disclosure is to provide an autonomous driving system that prevents a control-target vehicle from being erroneously recognized as an obstacle owing to presence of an error between a position detected through image recognition by a camera and a position detected by a sensor other than the camera.

An autonomous driving system according to the present disclosure is a system in which a control-target vehicle autonomously travels so as to avoid an obstacle, the system including: a first sensor placed near a road and configured to detect an object on the road by means of an image; a second sensor placed near the road and configured to detect an object on the road by means other than the image; and an obstacle recognition device configured to determine whether or not an object detected by each of the first sensor and the second sensor is an obstacle, wherein an object indicated by a detection point that is detected first by the second sensor and that is located within a certain distance range from a position of the control-target vehicle detected by the first sensor, is not determined as an obstacle.

The autonomous driving system according to the present disclosure can prevent a control-target vehicle from being erroneously recognized as an obstacle.

### BRIEF DESCRIPTION OF THE DRAWINGS

FIG. 1 illustrates a road-side sensor of an autonomous driving system according to a first embodiment;

FIG. 2 illustrates road-side sensors of the autonomous driving system according to the first embodiment;

FIG. 3 illustrates a schematic system configuration of the autonomous driving system according to the first embodiment;

FIG. 4 is a functional configuration diagram for explaining functions of an obstacle recognition device of the autonomous driving system according to the first embodiment;

FIGS. 5A to 5E each illustrate a road-side sensor integration unit of the obstacle recognition device in the first embodiment;

FIGS. 6A and 6B each illustrate an average image comparison unit of the obstacle recognition device in the first embodiment;

FIG. 7 illustrates an on-board sensor blind spot range inferring unit of the obstacle recognition device in the first embodiment;

FIG. 8 illustrates an operation of an erroneously-detected obstacle removal unit of the obstacle recognition device in the first embodiment;

FIG. 9 illustrates a tracking unit of the obstacle recognition device in the first embodiment;

FIG. 10 illustrates an operation of a control-target vehicle determination unit of the obstacle recognition device in the first embodiment;

FIG. 11 illustrates an operation of a nearby obstacle extraction unit of the obstacle recognition device in the first embodiment; and

FIG. 12 illustrates an example of hardware of the obstacle recognition device and an autonomous driving control device in the first embodiment.

### DETAILED DESCRIPTION OF THE PREFERRED EMBODIMENTS OF THE INVENTION

Hereinafter, an autonomous driving system according to a preferred embodiment of the present disclosure will be described with reference to the drawings. The same components and corresponding parts are denoted by the same reference characters, and detailed descriptions thereof will be omitted.

### First Embodiment

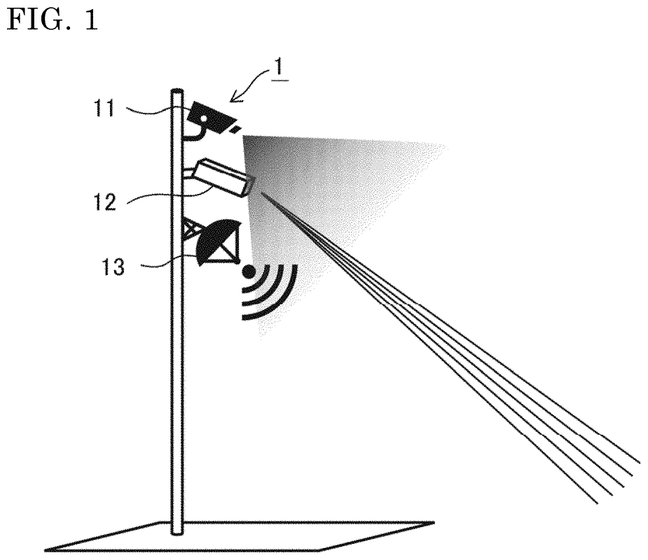

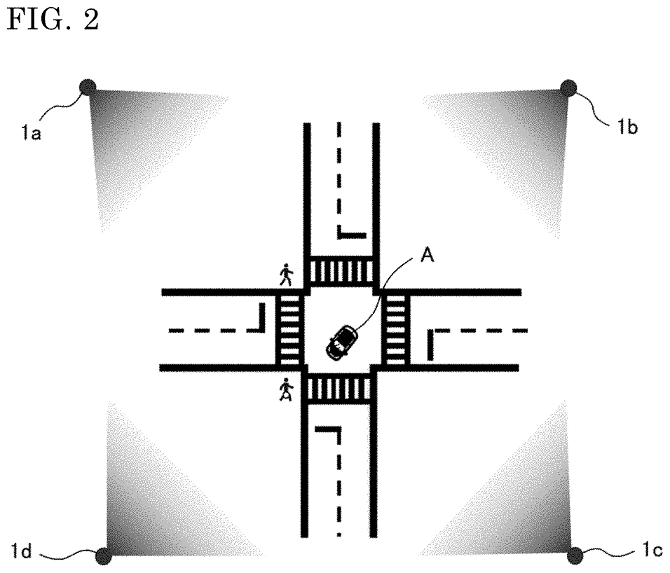

FIG. 1 illustrates an example of a road-side sensor of an autonomous driving system according to a first embodiment. As shown in FIG. 2, a plurality of road-side sensors 1 such as road-side sensors 1a, 1b, 1c, and 1d are placed near roads in an autonomous driving area and each detect objects, e.g., a vehicle, a pedestrian, and the like, on and near the roads. Each road-side sensor 1 includes an image recognition camera 11, a laser radar 12, and a millimeter wave radar 13. It is noted that the types of the sensors are not limited thereto.

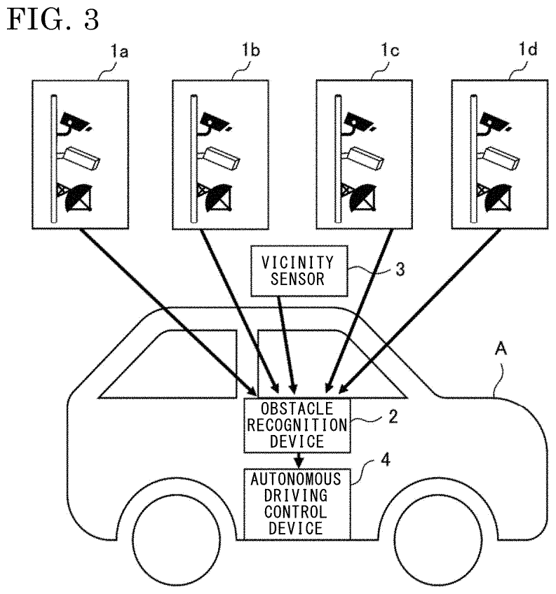

As shown in FIG. 3, detection results from the road-side sensors 1a, 1b, 1c, and 1d are transmitted to an obstacle recognition device 2 mounted in a control-target vehicle A to be subjected to autonomous driving control. Concurrently, an object detected by a vicinity sensor 3 disposed in the control-target vehicle A is also transmitted to the obstacle recognition device 2.

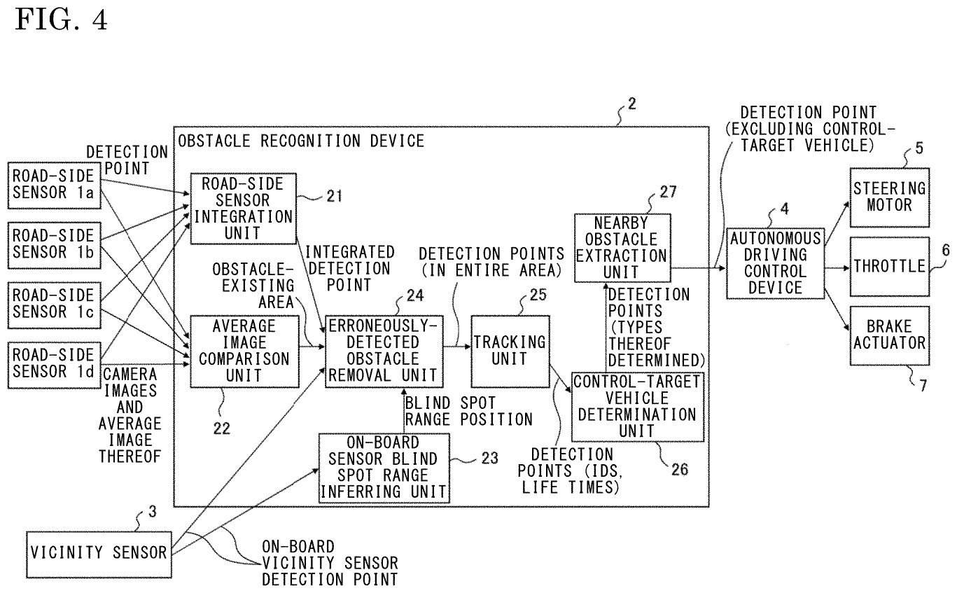

The obstacle recognition device 2 distinguishes the control-target vehicle A to be subjected to autonomous driving control and an obstacle for the control-target vehicle A, and transmits only information about the obstacle to an autonomous driving control device 4. The autonomous driving control device 4 controls a steering motor 5, a throttle 6, a brake actuator 7, and the like shown in FIG. 4 on the basis of the received positional information about the obstacle near the control-target vehicle A, so that autonomous travel toward a destination is performed so as to avoid the nearby obstacle.

Although a component representative of the vicinity sensor 3 is an entire-vicinity laser radar, the vicinity sensor 3 may be an image recognition camera that can watch the entire vicinity around the vehicle. Alternatively, the vicinity sensor 3 may be a millimeter wave radar or an ultrasonic sensor.

The obstacle recognition device 2 does not necessarily have to be mounted in the control-target vehicle A, and a configuration may be employed in which: the obstacle recognition device 2 is placed outside the control-target vehicle A; and only a result of performing a process is received by the control-target vehicle A.

Next, a configuration of the obstacle recognition device 2 will be described in detail. FIG. 4 is a functional configuration diagram of the obstacle recognition device. The obstacle recognition device 2 is composed mainly of seven functions which are a road-side sensor integration unit 21, an average image comparison unit 22, an on-board sensor blind spot range inferring unit 23, an erroneously-detected obstacle removal unit 24, a tracking unit 25, a control-target vehicle determination unit 26, and a nearby obstacle extraction unit 27. Each function will be described below.

Each of the road-side sensors 1a to 1d transmits the following pieces of information (1) and (2) to the obstacle recognition device 2.

(1) Information about a detection point detected by the road-side sensor 1 (the type and the position of a detected object)

The type of the object is, for example, a general object such as a pedestrian, a vehicle, the control-target vehicle, a burden, or an animal. The position of the object is a detection point from a road-side unit.

(2) The latest image and a long-period average image from the image recognition camera 11

The long-period average image is ultimately a background image including substantially no object.

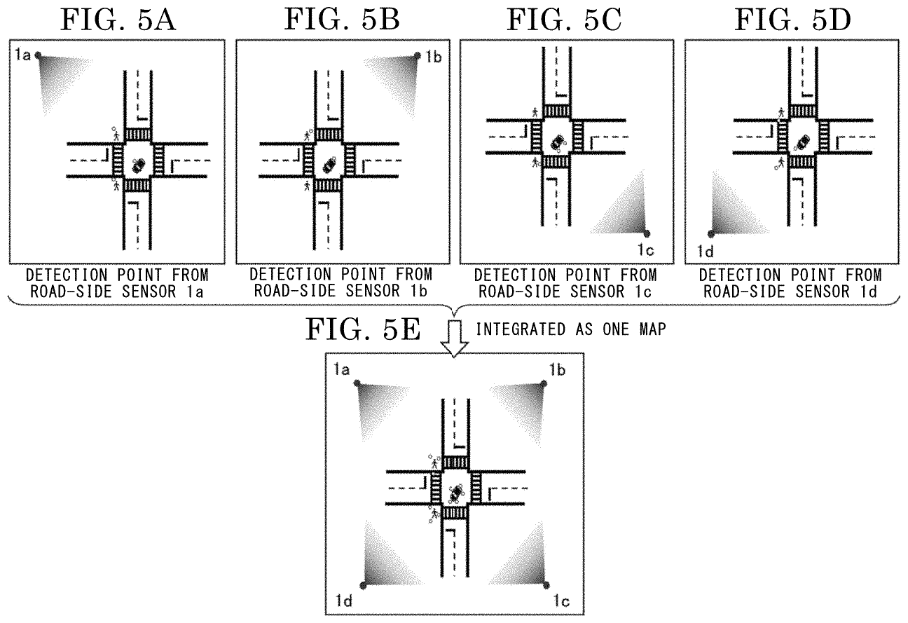

The road-side sensor integration unit 21 integrates the pieces of information about the detection points indicating target objects transmitted from the respective road-side sensors 1a to 1d, to acquire an obstacle map in the autonomous driving area. The pieces of information about the detection points are, for example, as indicated by circles near target objects such as persons and a vehicle in FIGS. 5A to 5E. These pieces of information indicate portions at which the target objects have been detected by the image recognition cameras 11 mounted to the road-side sensors 1a to 1d. In the present embodiment, the road-side sensors 1a to 1d detect, in four different directions, the target objects existing in the autonomous driving area, and the detection results are integrated by the road-side sensor integration unit 21 (see FIG. 5E). Although FIG. 5E explains only an operation of integrating the detection points to acquire one map, a process in which detection points indicating the same one of the objects are integrated to acquire one detection point may be performed. Pieces of information about detection points from the laser radars 12 and the millimeter wave radars 13 mounted to the road-side sensors 1a to 1d are also integrated onto maps in the same manner.

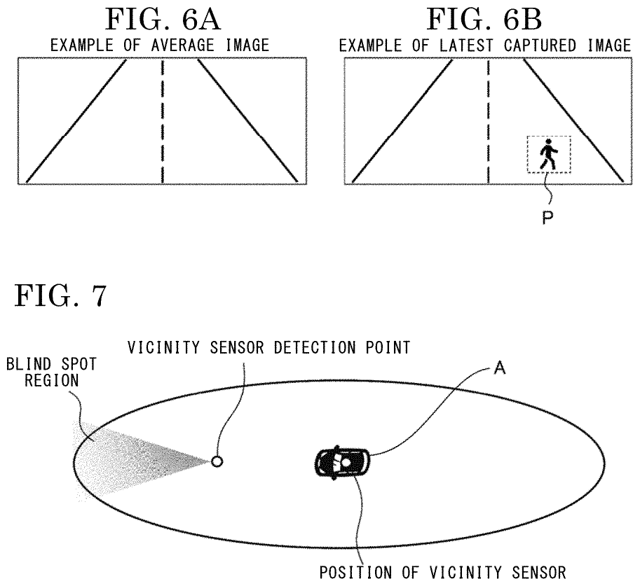

The average image comparison unit 22 compares the latest camera image and the long-period average image with each other and inputs, to the erroneously-detected obstacle removal unit 24, an image range in which a difference in the brightness of each pixel takes a value equal to or larger than a certain value. Description will be given with reference to FIG. 6A and FIG. 6B. FIG. 6A shows an average image obtained by: capturing a large number of images for a certain period (for example, several hours); calculating the sum of the values of each pixel in the respective images; and dividing the sum by the number of the images. Meanwhile, FIG. 6B shows an image captured at the latest timing. A difference in the brightness of each pixel between the image in FIG. 6A and the image in FIG. 6B is calculated. Consequently, a range P in which the difference in the brightness from the average image takes a value equal to or larger than a predetermined threshold value, is specified. The range P is distinguished as a region in which an obstacle might exist. Regarding the position of the range P, the position or the range is calculated by using generally known perspective projection transformation, and the position or the range is inputted to the erroneously-detected obstacle removal unit 24.

The on-board sensor blind spot range inferring unit 23 infers, on the basis of a detection point acquired from the vicinity sensor 3, a blind spot region not visible from the vicinity sensor 3 and inputs the region to the erroneously-detected obstacle removal unit 24.

Regarding specifics thereof, the on-board sensor blind spot range inferring unit 23 will be described with reference to FIG. 7. The vicinity sensor 3 cannot detect, if laser light therefrom is blocked by an obstacle, any object located forward of the obstacle. Therefore, a region located beyond the obstacle detected by the vicinity sensor 3 is a blind spot region as shown in FIG. 7. Information about the blind spot region is transmitted to the erroneously-detected obstacle removal unit 24.

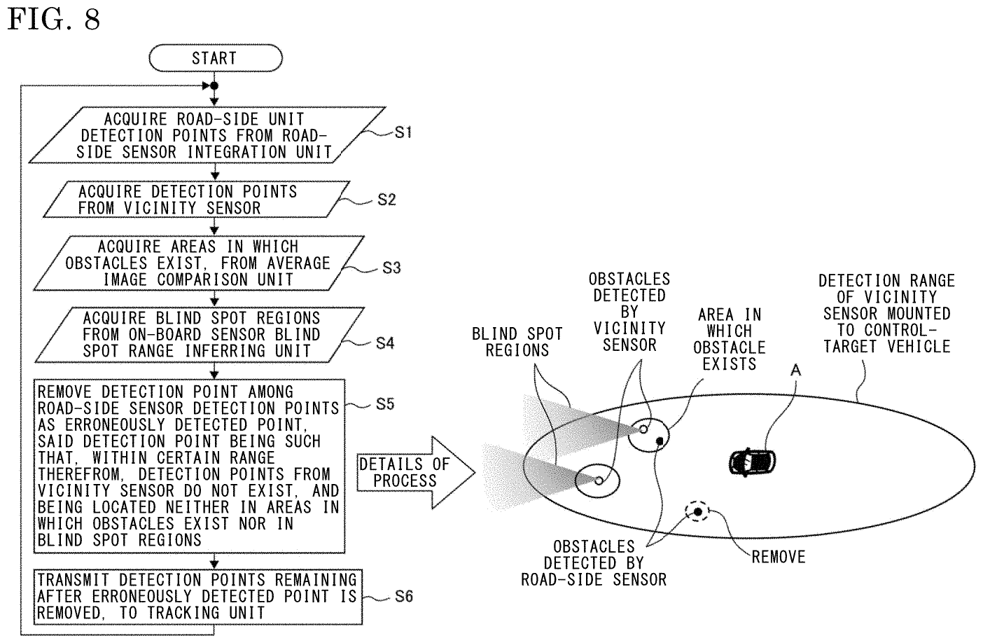

The erroneously-detected obstacle removal unit 24 removes an erroneously detected point on the basis of the detection points from the road-side sensors 1, the output from the average image comparison unit 22, the detection point from the vicinity sensor 3, and the output from the on-board sensor blind spot range inferring unit 23 which are described above. Regarding specifics thereof, an operation flow of the following processes (1) to (7) performed by the erroneously-detected obstacle removal unit 24 is shown in FIG. 8.

(1) First, detection points detected by the sensors mounted to road-side units are acquired from the road-side sensor integration unit 21 (step S1).

(2) Detection points are acquired from the vicinity sensor 3 (step S2).

(3) Areas in which obstacles exist are acquired from the average image comparison unit 22 (step S3).

(4) Blind spot regions are acquired from the on-board sensor blind spot range inferring unit 23 (step S4).

(5) Among the detection points acquired in step S1 and detected by the sensors mounted to the road-side units, a detection point is removed as an erroneously detected point, the detection point being such that, within a certain range therefrom, the detection points acquired in step S2 from the vicinity sensor 3 do not exist, and being located neither in the areas in which the obstacles exist and which are acquired in step S3 nor in the blind spot regions acquired in step S4 (step S5).

(6) Information about each detection point remaining after the erroneously detected point is removed is transmitted to the tracking unit 25 (step S6).

(7) The processes from step S1 to step S6 are repeated each time of acquiring a detection point.

Although the process (5) requires three conditions to be satisfied, a detection point satisfying at least one of the conditions may be determined as an erroneously detected point and removed depending on a road environment.

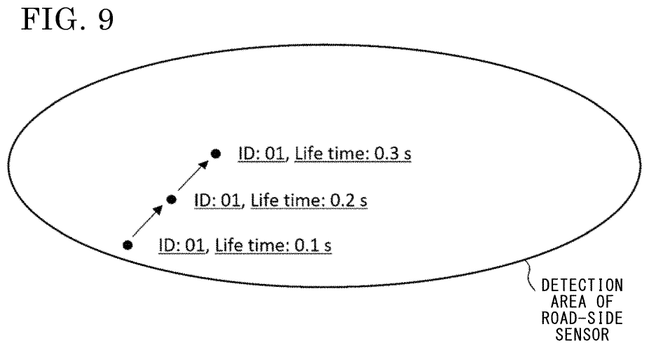

The tracking unit 25 adds, to the detection point remaining after the erroneously detected point is removed, an identifier (ID) which enables identification of the detection point and tracking times each of which is a time having elapsed from the start of tracking in a detection area of any of the road-side units. By tracking the detection point to which the ID and the tracking times are added, the time of emergence of the detection point is clarified. As shown in FIG. 9, from the time at which the detection point enters the detection area of any of the road-side sensors 1 and is detected, an ID is added, and furthermore, tracking times (life times) are added so as to ascertain tracking timings. Each tracking time only has to be information for ascertaining: whether the detection point has already been detected; whether the detection point has been newly detected this time; and whether the detection point is a known detection point to which an ID has already been added. Consequently, the relative position between the position of the control-target vehicle and the position of the detection point is clarified, and distinction is clearly made as to whether the detection point has entered or exited the detection area.

Regarding the pieces of information about the detection points acquired from the tracking unit 25, the control-target vehicle determination unit 26 determines which of the detection points indicates the control-target vehicle, on the basis of the type of each detection point, the position of emergence of the detection point, and a shift of the relative position from the control-target vehicle A.

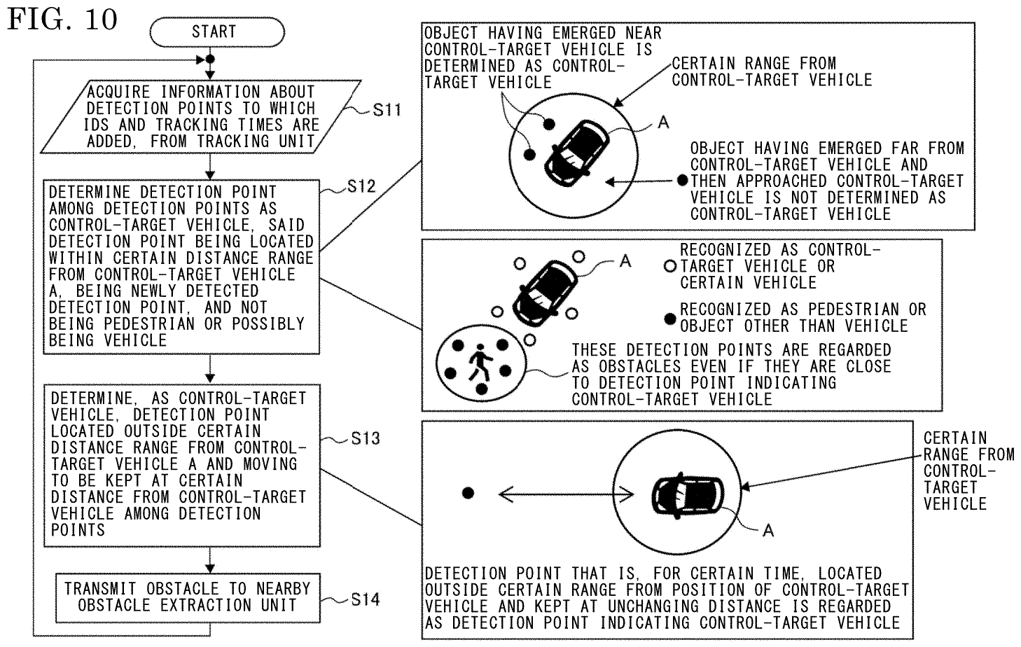

An operation flow of the following processes (1) to (5) performed by the control-target vehicle determination unit 26 is shown in FIG. 10.

(1) Pieces of information about the detection points to which the IDs and the tracking times are added are acquired from the tracking unit 25 (step S11).

(2) A position of the control-target vehicle A specified from characteristics of the appearance of the control-target vehicle by the image recognition cameras 11 mounted to the respective road-side sensors 1a, 1b, 1c, and 1d is received via the road-side sensor integration unit 21. A detection point is determined as the control-target vehicle, the detection point being located within a certain distance range from the position of the control-target vehicle A, the detection point being a newly detected detection point, the detection point not being a pedestrian but possibly being a vehicle, or being of an unidentified type (step S12).

(3) Therefore, a detection point having emerged at a position away from the control-target vehicle A and then approached the control-target vehicle A is not determined as the control-target vehicle.

(4) Among the detection points, a detection point that is located outside the certain distance range from the control-target vehicle A and that is moving to be kept at a certain distance from the control-target vehicle, is determined as the control-target vehicle (step S13).

(5) Information about each detection point determined not as the control-target vehicle A but as an obstacle is transmitted to the nearby obstacle extraction unit 27 (step S14).

The certain distance range described herein refers to a range that is based on the width and the length of the control-target vehicle A and an error in detection by each road-side sensor and in which a detection point derived from the control-target vehicle A possibly emerges from the position of the control-target vehicle A.

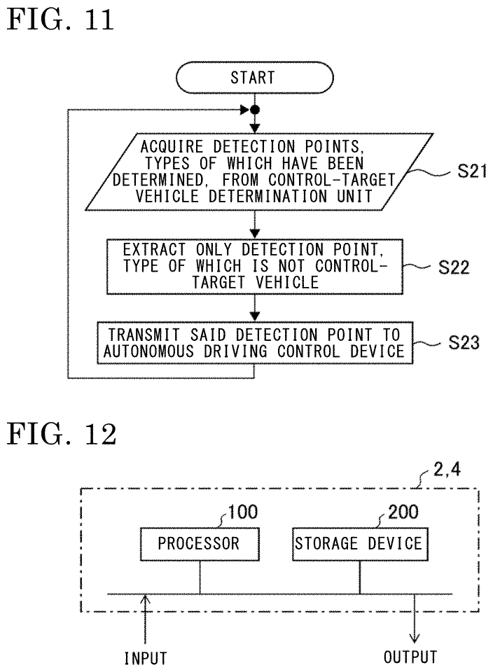

As indicated by an operation flow in FIG. 11, the nearby obstacle extraction unit 27 acquires, from the control-target vehicle determination unit 26, the detection points the types of which have been determined (step S21). Then, from among the detection points, a detection point the type of which is not the control-target vehicle is extracted, i.e., a detection point indicating an obstacle is extracted (step S22). Information about the extracted detection point indicating the obstacle is transmitted to the autonomous driving control device 4 (step S23).

The obstacle recognition device 2 composed of the above components performs the following processes.

(1) A detection point detected by each road-side sensor 1 and existing within the certain distance range from the position of the control-target vehicle A specified by the image recognition camera 11 of each road-side unit, is not regarded as an obstacle. However, there are exceptions (2) and (3).

(2) A detection point captured first outside the certain distance range from the position of the control-target vehicle A and then having entered the certain distance range, is regarded as an obstacle.

(3) If a detection point that has been captured by the image recognition camera 11 and that is of a type obviously different from the control-target vehicle A enters the certain distance range from the position of the control-target vehicle A, the detection point is regarded as an obstacle.

(4) The vicinity sensor 3 such as an entire-vicinity laser radar mounted to the control-target vehicle A detects an obstacle near the vehicle in order to prevent a detection point from being determined as an obstacle, the detection point having been determined as existing outside the certain distance range since there is a great error between the position of the control-target vehicle A specified by the image recognition camera 11 and the position of the control-target vehicle A detected by any road-side sensor 1 other than the image recognition camera 11. Consequently, a detection point detected by the road-side sensor 1 and not existing within a certain range from the position of a detection point detected as an obstacle by the vicinity sensor 3, is not regarded as an obstacle. It is desirable to use, as the certain range, a range in which the same object as that detected by the vicinity sensor 3 is possibly detected by the road-side sensor 1 on the basis of a sensor-detected position error, for example.

(5) A region behind the position of an obstacle detected by the vicinity sensor 3 is set as a blind spot region, and a detection point existing in the blind spot region is regarded as an obstacle such that a detection point detected by the road-side sensor 1 is prevented from being in a state of not being regarded as an obstacle if the detection point exists at a position not visible from the vicinity sensor 3 and is not detected.

(6) A detection point the relative position of which remains unchanged with respect to the control-target vehicle A for a certain time, is not regarded as an obstacle in order to prevent a detection point from being determined as an obstacle, the detection point having been determined as existing outside the certain distance range since there is a great error between the position of the control-target vehicle A specified by the image recognition camera 11 and the position of the control-target vehicle A detected by any road-side sensor 1 other than the image recognition camera 11.

(7) A detection point existing in a region in which the difference of each pixel value is smaller than a threshold value in comparison between the long-period average image and the latest image from the image recognition camera 11, is not regarded as an obstacle in order to prevent a detection point from being determined as an obstacle, the detection point having been determined as existing outside the certain distance range since there is a great error between the position of the control-target vehicle A specified by the image recognition camera 11 and the position of the control-target vehicle A detected by any road-side sensor 1 other than the image recognition camera 11.

As the threshold value for the pixel value, it is desirable to experimentally acquire, in a place where the road-side sensors 1 are placed, such a value that the difference of each pixel value is assuredly prevented from becoming smaller than the threshold value when an obstacle exists, in order to prevent a detection point from erroneously failing to be regarded as an obstacle.

An example of hardware in the obstacle recognition device 2 and the autonomous driving control device 4 is shown in FIG. 12. The hardware is composed of a processor 100 and a storage device 200. The storage device includes a volatile storage device such as a random access memory, and a nonvolatile auxiliary storage device such as a flash memory. Alternatively, the storage device may include, as the auxiliary storage device, a hard disk instead of a flash memory. The processor 100 executes a program inputted from the storage device 200 and executes, for example, each function of the obstacle recognition device described above. In this case, the program is inputted from the auxiliary storage device via the volatile storage device to the processor 100. Further, the processor 100 may output data such as a computation result to the volatile storage device of the storage device 200 or may save the data via the volatile storage device into the auxiliary storage device.

As described above, the present embodiment can prevent a control-target vehicle from being erroneously recognized as an obstacle even if there is an error between a position detected through image recognition by a camera and a position detected by a sensor other than the camera.

Although the disclosure is described above in terms of an exemplary embodiment, it should be understood that the various features, aspects, and functionality described in the embodiment are not limited in their applicability to the particular embodiment with which they are described, but instead can be applied alone or in various combinations to the embodiment of the disclosure.

It is therefore understood that numerous modifications which have not been exemplified can be devised without departing from the scope of the specification of the present disclosure. For example, at least one of the constituent components may be modified, added, or eliminated.

### DESCRIPTION OF THE REFERENCE CHARACTERS

1 road-side sensor

2 obstacle recognition device

3 vicinity sensor

4 autonomous driving control device

5 steering motor

6 throttle

7 brake actuator

11 image recognition camera

12 laser radar

13 millimeter wave radar

21 road-side sensor integration unit

22 average image comparison unit

23 on-board sensor blind spot range inferring unit

24 erroneously-detected obstacle removal unit

25 tracking unit

26 control-target vehicle determination unit

27 nearby obstacle extraction unit

What is claimed is:

1. An autonomous driving system in which a control-target vehicle autonomously travels so as to avoid an obstacle, the autonomous driving system comprising:
a first sensor placed near a road and configured to detect an object on the road by means of an image;
a second sensor placed near the road and configured to detect an object on the road by means other than the image; and
an obstacle recognition device configured to determine whether or not an object detected by each of the first sensor and the second sensor is an obstacle, wherein
an object indicated by a detection point that is detected first by the second sensor and that is located within a certain distance range from a position of the control-target vehicle detected by the first sensor, is not determined as an obstacle.

2. The autonomous driving system according to claim 1, wherein an object indicated by a detection point that, after being detected by the first sensor or the second sensor outside the certain distance range from the position of the control-target vehicle detected by the first sensor, is detected again by the first sensor or the second sensor within the range, is determined as an obstacle.

3. The autonomous driving system according to claim 1, wherein an object indicated by a detection point that, after being detected by the first sensor or the second sensor outside the certain distance range from the position of the control-target vehicle detected by the first sensor, is kept at an unchanging relative distance from a detection point indicating the control-target vehicle, is not determined as an obstacle.

4. The autonomous driving system according to claim 1, wherein, if an image of the detection point detected by the first sensor indicates an object different from the control-target vehicle, the object is determined as an obstacle.

5. An autonomous driving system in which a control-target vehicle autonomously travels so as to avoid an obstacle, the autonomous driving system comprising:
a first sensor placed near a road and configured to detect an object on the road by means of an image;
a second sensor placed near the road and configured to detect an object on the road by means other than the image;
a vicinity sensor disposed in the control-target vehicle and configured to detect an object near the control-target vehicle; and
an obstacle recognition device configured to determine whether or not an object indicated by a detection point detected by each of the first sensor, the second sensor, and the vicinity sensor is an obstacle, wherein
if a detection point detected by each of at least two of the sensors is located within a predetermined distance range, the detection point is determined as an obstacle.

6. The autonomous driving system according to claim 5, wherein an object indicated by a detection point that is detected by the first sensor or the second sensor and that is located in a region on an opposite side to the control-target vehicle relative to a detection point detected by the vicinity sensor, is not determined as an obstacle.

7. The autonomous driving system according to claim 1, wherein a portion in which a difference in brightness between an average image of previous images acquired over a predetermined period and a present image from the first sensor takes a value larger than a predetermined threshold value, is determined as an obstacle.

8. The autonomous driving system according to claim 2, wherein a portion in which a difference in brightness between an average image of previous images acquired over a predetermined period and a present image from the first sensor takes a value larger than a predetermined threshold value, is determined as an obstacle.

9. The autonomous driving system according to claim 3, wherein a portion in which a difference in brightness between an average image of previous images acquired over a predetermined period and a present image from the first sensor takes a value larger than a predetermined threshold value, is determined as an obstacle.

10. The autonomous driving system according to claim 4, wherein a portion in which a difference in brightness between an average image of previous images acquired over a predetermined period and a present image from the first sensor takes a value larger than a predetermined threshold value, is determined as an obstacle.

11. The autonomous driving system according to claim 5, wherein a portion in which a difference in brightness between an average image of previous images acquired over a predetermined period and a present image from the first sensor takes a value larger than a predetermined threshold value, is determined as an obstacle.

12. The autonomous driving system according to claim 6, wherein a portion in which a difference in brightness between an average image of previous images acquired over a predetermined period and a present image from the first sensor takes a value larger than a predetermined threshold value, is determined as an obstacle.
